(19) United States
(12) Patent Application Publication
(10) Pub. No.: US 2016/0045811 A1
(43) Pub. Date: Feb. 18, 2016

(54) Multi-Functional Digital Display System

(71) Applicants: Gordon Klein, Albuquerque, NM (US); Joseph Lyle, Albuquerque, NM (US)

(72) Inventors: Gordon Klein, Albuquerque, NM (US); Joseph Lyle, Albuquerque, NM (US)

(21) Appl. No.: 14/459,942

(22) Filed: Aug. 14, 2014

(51) Int. Cl. A63B 71/06; G07C 1/22

(52) U.S. Cl. CPC A63B 71/0619; G07C 1/22

(57) ABSTRACT

Disclosed is a multi-functional digital display system capable of delivering a complete event scorekeeping display and tracking system which is also capable of delivering alternative digital content, such as digital advertising. This system is based around a self-contained device incorporating a processor, a web server, data storage, as wireless access point, and embedded software. This device delivers a very flexible solution which can be connected to a wide variety of commercial devices, such as a television, in order to display the scorekeeping system, and can be connected to a wide variety of commercial devices, such as a smart phone, for controlling the scorekeeping and management functions. As such, this system can adapt to evolving display and wireless device technology, while continuing to expand its capabilities via evolving software functionality. The result is a lower cost, more capable, and more flexible system than was previously possible.

### CROSS REFERENCE TO RELATED APPLICATIONS

None.

### STATEMENT REGARDING FEDERALLY SPONSORED R&D

None.

### NAMES OF PARTIES TO A JOINT RESEARCH AGREEMENT

None.

### REFERENCE TO A SEQUENCE LISTING

None.

### STATEMENT REGARDING PRIOR DISCLOSURES BY ANY INVENTOR

Inventor installed an experimental system on Feb. 18, 2014.

### BACKGROUND OF THE INVENTION

1. Field of the Invention

The present invention relates to a multi-functional digital display system capable of delivering a complete event scorekeeping display and tracking system which is also capable of delivering alternative digital content, such as digital advertising.

2. Description of the Prior Art

At smaller sporting venues such as schools, churches, community centers, and indoor sports arenas, the scorekeeping device, if there is one, is typically a single purpose device capable only of delivering the data related to the sport being played. These devices have not significantly improved in many years. Recent inventions related to such devices continue to have many shortcomings, which may be why older technology continues to dominate this market. For example, due to the limited space available on the scoreboard display, the scoreboard is limited to a specific set of sports which it can support given the data fields available on the display. If you want to enable further sports, you must buy a larger and more complex scoreboard. If you want to display something other than the data fields for which the scoreboard is built, you have no means of doing so. Controlling such a scoreboard is also a challenge. Not only are the data fields on the scoreboard fixed, but the controls for those data fields are permanently displayed on the controlling units as well. Thus, the user must navigate through all of the controls even though they may be using only a few. Most of these systems are based on proprietary and specialized display and control hardware which is not flexible or adaptable to rapidly changing technology. Thus, these systems are largely out of date as soon as they are installed. Some recent inventions describe methods of using standard digital display devices, such as televisions, in systems either along side the scoreboard system or to some degree integrated with the scoreboard system. However, these inventions are complex to implement and maintain, and yet still do not have the capabilities to support more involved sports requiring accurate, real time clocks and other functions for managing the event.

U.S. Pat. No. 7,898,393 (Wall mounted scoreboard) describes a wall mounted display system with an associated remote control device. This invention is limited in its capability, which is restricted to scorekeeping and timing functions. It can not provide any customization of the scoreboard display and can not deliver any digital content other than the scorekeeping data for which it is intended. It is also not easily updated or adapted to new technology as it evolves. This is purely a proprietary hardware solution which is difficult to maintain and is out of date from the time it is purchased.

CA 2695959 (Method and system for an intelligent portablescoreboard with customizable and self officiating capabilities) describes a portable version of a scoreboard system. This invention is limited in both its practical visibility and its capabilities. It can only keep simple scores using a specialized controller and proprietary display device. It can not provide any customization of the scoreboard display and can not deliver any digital content other than the scorekeeping data for which it is intended. It is also not easily updated or adapted to new technology as it evolves. This is purely a proprietary hardware solution which is difficult to maintain and is out of date from the time it is purchased.

CA 2804705 (Sports scorekeeping system with integrated scoreboard and automatic entertainment system) describes an intermediate device intended to communicate with an existing scoreboard system as well as additional display or entertainment devices by training or custom programming this intermediate device to speak to those devices. This is a highly complex system to implement and maintain, which may explain why it has not been widely adopted. An additional weakness of this device is that, because it is simply driving existing systems, it is inherently limited in its capabilities. Over time, its value decreases with the age of the system to which it is trained.

WO 2009070026 (Digital Scoreboard) discloses a method of creating a digital type of scoreboard which can include digital advertising. This method focuses on very simple scoreboard functions for tracking the results of very simple games, such as billiards, darts, and card games. It does not provide for the more complex functions required to deliver a functional scoreboard for a broader range of games which require an accurate and controllable clock. This method depends on third party computer systems and wireless networks which must be implemented, configured and maintained in order to keep the system functioning. This dependency creates a vulnerability that prevents this method from supporting time sensitive and more complex sporting events. In addition, though this method provides for the inclusion of digital advertising, it does not include a method for sourcing and managing that content, nor any concept of facilitating the purchasing and payment process associated with acquiring and delivering that content as paid advertising.

US 20140064701 (Broadcast management system) discloses a method to collect video content from a variety of sources at a live event and provide a management system which allows that content to be broadcast to interested parties—either on screens at the event or remotely via the internet. This method is a video collection and distribution system. It does not include the capability of a bi-directional, real-time control system where a connected device can drive the scoreboard and control critical functions of a game, such as a clock.

WO 2013039542 (Digital advertising system) describes a method focused on using external data such as the local weather and profile information about a viewer to make effective content selections for digital advertising. This claim is based on automated content selection, and does not include any method of enabling the display system on which the content is delivered.

### SUMMARY OF THE INVENTION

The present invention is a multi-functional digital display system which is capable of performing many functions. One objective of the present invention is to provide a digital display system that can be used to manage and execute a wide range of live events, especially sporting events. The present invention incorporates an embedded web server, a processor, data storage, a wireless access point, and embedded software creating a scorekeeping system that is not dependent on external computers or network systems for any of its core scorekeeping functions. The present invention is also capable of much more than a typical scorekeeping system. The embedded software allows the scorekeeping functions to be switched to an endless number of sports, presenting only the required data and controls for managing each sport. The display interface can be setup specifically for each event incorporating team names, logos, colors, and other options. The actual controls available for any given event can be customized as well. For example, if you don't need to track player fouls or penalties, those can be turned off on the display as well as on the controller.

A second objective of the present invention is to provide a digital display system that is highly flexible and adaptable to changing technology. The core of the multi-functional digital display system is a self-contained device which can be connected to a wide variety of standard digital display devices for delivering the actual display. That is, the multi-functional digital display system can be connected to a television, a digital projector, an LED panel, or other commercially available display device. This means that the system is extremely flexible and even portable as it can be used to create a multi-functional digital display system in any location where you have a display device to connect it to. This also means that as display technology evolves, this system can adapt to new devices.

There is another important factor in the flexibility and adaptability of this system—how you control the system. The multi-functional digital display system can be controlled from a wide variety of standard wireless devices, such as a phone, a tablet, a laptop, and so forth. There is no need for the complex control units required in many prior inventions. This system can be run from any wireless device which is granted access.

Another objective of the present invention is to enable the delivery of alternative digital content, including digital advertising content, directly on the display being used for the scoreboard itself. This alternative content can be displayed along with the event data, as an overlay on top of the event data, or in place of the event data altogether. The display of this advertising can be controlled directly from the same wireless devices which are controlling the scorekeeping.

Another objective of the present invention is to allow event data to be broadcast to devices outside of the location in which the event is occurring without significant extra effort. To this end, the present invention can be connected to the internet via a separate, standard connection such that the local scorekeeping data can be made available to a wide range of devices via the internet. Thus, mobile devices may receive a live feed from a specific venue telling a user how much time is left, or what the score is, even when they can't be present.

A final objective of the present invention is to significantly improve the ability to collect, manage, and display alternative digital content, such as digital advertising. Once this invention is connected to the internet, a web server based system will allow interested parties, perhaps parents or local businesses, to submit digital advertising that they want to have shown on the multi-functional digital display system. The owner of the system can set the terms and approve or reject the submitted content all via the internet. Once accepted, the content is automatically displayed during the next event.

### BRIEF DESCRIPTION OF THE DRAWINGS

FIG. 1—Plan view of multi-functional digital display system in Best Mode conception

FIG. 2—Plan view of multi-functional digital display system with single display

FIG. 3—Plan view of multi-functional digital display system with multiple displays and multiple controllers

FIG. 4—Plan view of multi-functional digital display system with internet connection for remote/mobile viewing

FIG. 5—Plan view of multi-functional digital display system with internet connection for content management system

FIG. 6—Workflow diagram for achieving method of mobile viewing

FIG. 7—Workflow diagram for achieving method of content management for multiple systems

### DETAILED DESCRIPTION OF THE INVENTION

### Definitions

The term Standard Digital Display Device will be used to represent the group of devices intended for graphically displaying digital data including televisions, digital projectors, LED display panels, LCD display panels, or any current or future digital device intended for displaying digital, graphical content.

The term Standard Wireless Device will be used to represent a group of devices which are capable of connecting to a wireless access point and operating a web browser or installed applications (apps). This group includes smart phones, tablets, laptops, desktops or any other current or future device incorporating the required capabilities.

The term Standard will be used to represent an entity or methodology with is generally accepted by the associated industry.

The term Standard Power Supply will be used to represent a power source intended to supply electrical power to an electrical device. This may include a standard wall outlet, a power supply system, such as an uninterruptable power supply (UPS), a USE power supply from another device, a CAT6 power over Ethernet supply, or any other power supply technology capable of delivering the appropriate level of stable electrical power.

The term Wireless Access Point will be used to represent a device which is capable of broadcasting a wireless signal (Wi-Fi) for the purposes of connecting a receiving device (client) to a server device (server) allowing bi-directional communication between the devices. This is commonly referred to as a wireless network.

The term Standard Wireless Connection will be used to represent a standardized protocol for communication between a wireless device and a wireless access point that does not depend on physical media. This includes the group of standard protocols such as WiFi, Bluetooth, WirelessHD, WiGig, Z-wave, Zigbee, as well as other standards that may be developed in the future.

The term Standard Display Connection will be used to represent a standard, commercially available data connector intended to allow communication of graphical and audio data. This group of standardized connectors includes High Definition Multimedia Interface (HDMI), Display Port, HDBaseT, IEEE 1394 Firewire, Coaxial, Optical, as well as other standard connectors which may be developed in the future.

The term Alternative Digital Content will be used to indicate digital content which is not Event Data but is other digital content which is presented via the digital display device including text, images, videos, or audio content, as well as other digital content which may developed in the future.

The term Event Data will be used to represent information which is tracked for purposes of executing, managing, measuring, or supporting an event which is being conducted via the use of the multi-functional digital display device. This may include a clock function for the purposes of keeping track of the amount of time that has passed by starting and stopping the clock as needed. This may include score keeping functions for tracking the points achieved by any particular participant in the event. This may include results tracking functions for storing the outcomes and data of multiple events over time. This may also include functions for identifying details about the participants, the progress of the event, or making comparisons between participants or results.

The term Server Device will be used to represent a multi-functional digital display device that functions as the primary device in a multi-functional digital display system. It is this device which provides the Wireless. Access Point to which any standard wireless devices which are connected, and to which any multi-functional digital display Client devices are connected.

The term Remote Devices will be used to represent devices which are connected to the internee but are not actually present at the location at which an event is being conducted.

The term Device Registration System will be used to represent a software system and method whereby a specific installation of the multi-functional digital display system can be identified and appropriately categorized by an internet-based web server system for the purpose of establishing ongoing communication between these two systems.

The term Event Registration System will be used to represent a software system and method whereby a specific event being executed through a specific installation of the multi-functional digital display system can be identified and appropriately categorized by an internet-based web server system for the purpose of establishing ongoing communication between these two systems regarding that specific event.

The term Standard Authentication Protocol will be used to represent a means of allowing a user to access a software system by supplying appropriate identification information and appropriate security information. This may include a username and a password, or another similar method which allows the system to identify the user and provide appropriate access rights based on their identity.

The term Access Rights will be used to represent an appropriate set of functions and options which are made available to a user on a software system based on their identity.

The term Web Server System will be used to represent a software system which is accessible via the internet and which enables bi-directional communication between the server and any device which connects to that server via the internet.

The term Administrator will be used to represent a user who is registered with a specific multi-functional digital display system and identified as having the rights and access to control all aspects of the system and take appropriate actions within the system.

### BEST MODE

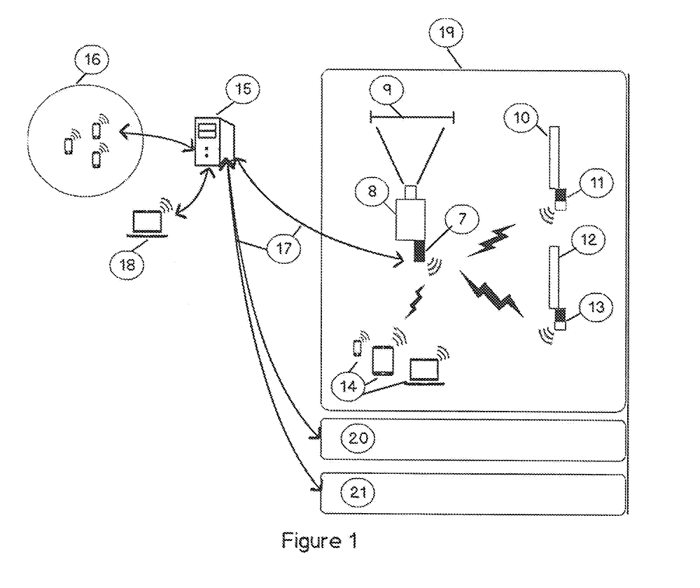

FIG. 1 shows a schematic view of the best mode contemplated by the inventor of the multi-functional scoreboard and digital advertising system ‘xx’ according to the concepts of the present invention.

### How to Make the Invention

The multi-functional digital display system must include a multi-functional digital display server device. The server device is a self contained device incorporating a processor, data storage, a database, a web server, a wireless access point, and software such that all the intelligence and communication required to enable the digital display of event data and alternative digital content are centralized within this device. However, both the control of this invention (the input) and the display of this invention (the output) can be achieved using a wide variety of commercial products.

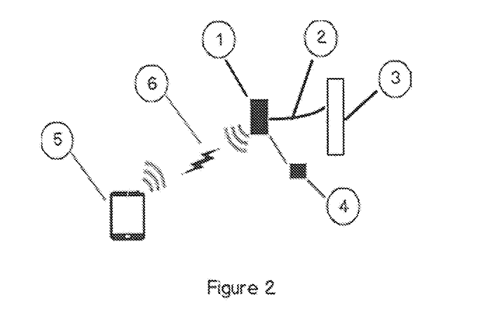

FIG. 2 shows a basic implementation of the multi-functional digital display system. Included is one multi-functional digital display server device 1, one standard digital display device 3, in this case a television, and one standard wireless device 5, in this case a tablet device. The output of the multi-functional digital display server device 1 is connected to the television 3 via a standard display connection 2 and to a standard power supply 4. The output of the multi-functional digital display server device 1 is presented on the television 3, providing the appropriate view of the event data for those present at the event. All event data and alternative digital content are presented via the television 3. At the same time, the multi-functional digital display server device 1 broadcasts a wireless signal to allow a standard wireless device 5 to connect using a standard wireless connection 6 for the purposes of controlling the system. A wide variety of standard wireless devices can be used, as described in the definition of standard wireless devices. In FIG. 2, a single standard wireless device 5 is connected to the wireless access point provided by the multi-functional digital display server device 1. Once connected, this standard wireless device 5 can now view a software interface providing a set of functions for controlling the system. The functions made available via this software interface may include, but are not limited to: a clock function for keeping track of time remaining or time elapsed in an event including the ability to control the clock as needed (e.g. start, stop, reset, edit); scorekeeping functions for tracking the points or results achieved by any participating party; functions for tracking or measuring the status, progress or change of any participating party or of the event itself.

The display output of the multi-functional digital display server device can be connected to a variety of standard digital display devices, as described in the definition of standard digital display devices. This connection can be made using a variety of standard display connections, as described in the definition of standard display connections.

In terms of the input or control of this system, a wide variety of standard wireless devices can be used as described in the definition of standard wireless devices.

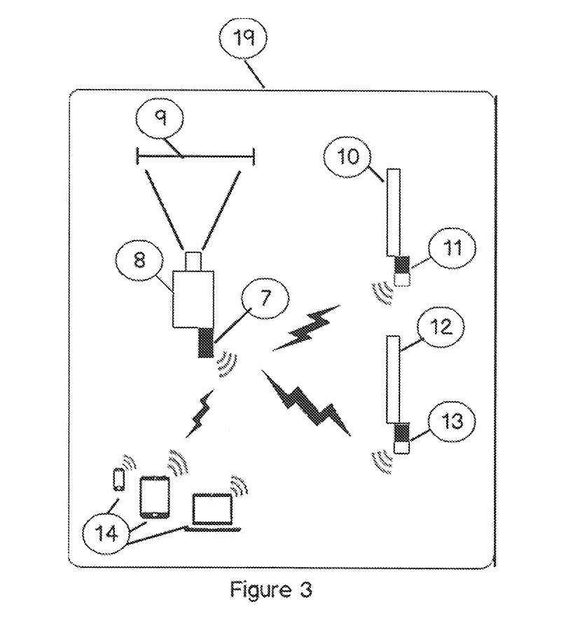

FIG. 3 illustrates an alternative conception of the system. In this conception, three multi-functional digital display devices 7, 11, 13 are connected to three separate standard digital display devices 8, 10, 12, creating a multi-functional digital display system 19 with three connected displays. In this conception, one multi-functional digital display device is the server device 7, and the other two multi-functional digital display devices are client devices 11, 13. The server device 7 is the primary multifunctional digital display device in the system. The server device 7 provides the wireless access point to which any connected standard wireless devices 14 connect for the purpose of controlling the system. The server device 7 is responsible for receiving input and commands from the controlling standard wireless devices 14, and for sharing the appropriate event data and alternative digital content to the client devices 11, 13 via the wireless access point. Thus, with a server device 7 and two client devices 11, 13 in this conception, the multi-functional digital display system 19 creates a three-screen synchronized display system without the need for any physical media (wiring) between the standard digital display devices 8, 10, 12.

In the conception represented in FIG. 3, one standard digital display device is a projector 8, a second standard display device is a television 10, and a third standard display device is an LED panel 12. It is conceivable that a multi-functional digital display system could be created with any number of connected client devices and standard digital display devices

FIG. 3 also illustrates a conception where there are multiple standard wireless devices 14 controlling the multi-functional digital display server device 8. In FIG. 3, one standard wireless device is a smartphone, one standard wireless device is a tablet, and one standard wireless device is a laptop computer. However, this system is not limited to these types of devices, as described in the definition of standard wireless devices. In this conception, each standard wireless device 14 would be granted access to control the system via a standard authentication protocol. In this way, each authenticated device can be granted specific permissions or access rights for controlling the system.

An alternative conception of the system is one in which the event data or results of any event are written to a database and stored in permanent memory multi-functional digital display server device. In this conception, the multi-functional digital display system is capable of storing the results of multiple events over time and then manipulating this data to provide comparisons, statistics, competitive results, or other data transformations as needed. This data can then be presented in various formats on the standard digital display devices in the system. Alternatively, this data could be presented on any standard wireless device which is connected to the system.

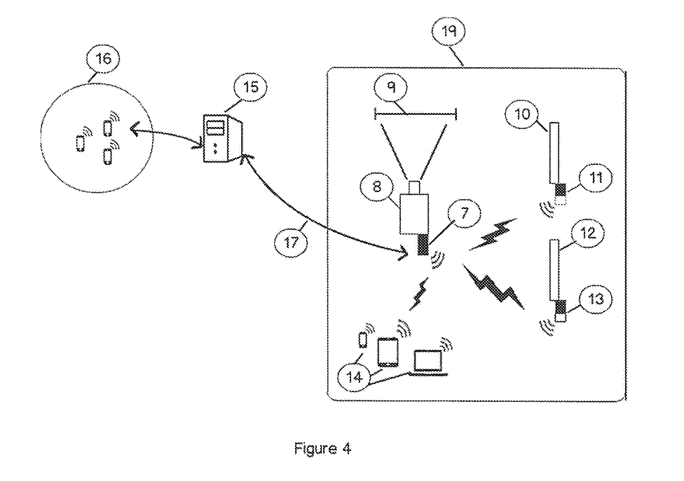

FIG. 4 illustrates an alternative conception of the system wherein the multi-functional digital display server device is also connected to the internet via a standard wired or wireless connection 17. In this conception, the current data from the multi-functional digital display server device 7 would be published to a web server on the internet 15 so that this data would also be available remotely to devices which may or may not be at the event 16. Thus, users on remote devices 16 can connect to the web server 15 in order to view the event data at any given time.

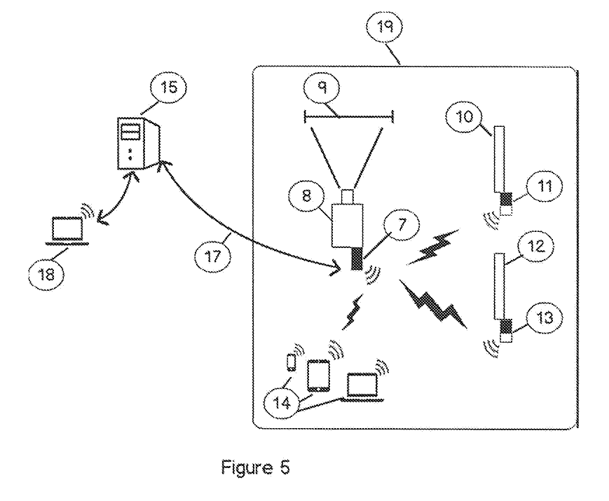

FIG. 5 illustrates an alternative conception of the system wherein the multi-functional digital display server device is also connected to the internet via a standard wired or wireless connection 17. In this conception, the connection to the internet 17 provides the ability to supply information to a multi-functional digital display server device 7 from a remote device 18, via, the web server system 15. This would be achieved by first connecting a multi-functional digital display server device to the internet, and then registering this system with a web server system 15 so that the specific multi-functional digital display system is identified and appropriately categorized by this web server system 15. A user on a remote device 18 may then access the website provided by the web server system 15 and may provide input to a specific, known multi-functional digital display server device 7. This input may include information related to or affecting the event data or it may be alternative digital content. If the input is related to the current event data, then the users on the remote devices may be capable of interacting with or participating in events being managed on the multi-functional digital display system 19. If the input is alternative digital content, such as digital advertising, this conception provides for an internet-based content management system for receiving, managing, and displaying alternative digital content on any multi-functional digital display system 19.

As illustrated in FIG. 1, this conception may be extended to include more than one multi-functional digital display system 19, 20, 21 connected to the web server system 15 such that users may provide content to more than one multi-functional digital display system 19, 20, 21. In this conception, it is conceivable that an automated system may be created to allow customers interested in displaying their content on one or more multi-functional digital display systems 19, 20, 21 to provide their content and pay for the privilege of having it displayed via a website or application.

### How to Use the Invention

The problems addressed by the multi-functional digital display system are many as can be easily seen by those skilled in this art. The multi-functional digital display system combines a fully functional scoreboard system with a system for delivering alternative digital content. The multi-functional digital display system adapts to many types of standard digital display devices eliminating dependency on proprietary display hardware that is quickly outdated and difficult to maintain. The multi-functional digital display system allows more than one standard digital display device to be linked together in a synchronized display system. The multi-functional digital display system adapts to many types of standard wireless devices for controlling the multi-functional digital display system, eliminating dependency on proprietary hardware that is quickly outdated and difficult to maintain. The flexibility to adapt to multiple standard digital display devices and control devices creates a system which can expand its capabilities and adapt to new technology as it becomes available. This is a fundamental improvement over the existing systems which become outdated as soon as they are built.

The multi-functional digital display system eliminates unused or unwanted data. It allows the controller to switch between event types such that both the digital display and the controller only present the data relevant to the current event, making the system simple to understand and use both for those managing the event and those watching or participating in the event. For example, if you are controlling a basketball game, you only see the controls appropriate for basketball. Likewise, the spectators and participants only see the data fields on the display that are appropriate for basketball. If you are running another type of event, then you only need to see and control the data that is related to that event.

The multi-functional digital display system conceivably allows a single controller to control all aspects of an event, eliminating the need to have multiple people running the event. The multi-functional digital display system provides the flexibility to share the control of the event so that multiple people can control different parts of the event management responsibilities.

The multi-functional digital display system allows the digital display to be easily customized. This includes, but is not limited to, showing the names of the teams or participants, showing additional details about the teams, participants, the facility, the event, or sponsors such as logos, graphics, text, audio, or video.

The multi-functional digital display system allows a user who is controlling the system to post dynamic content in the form of text, graphics, audio, or video directly via the digital display in order to make announcements or advertisements which are integrated with event data.

The multi-functional digital display system allows a user who is controlling the system to choose a preconfigured display type for any connected digital display. These display types include different configurations of event data and alternative digital content.

The multi-functional digital display system can store the results of an event so that the information from any event is not lost when the event is over. The resulting data can provide a system that can track results over time for multiple events and teams such as a tournament result bracket.

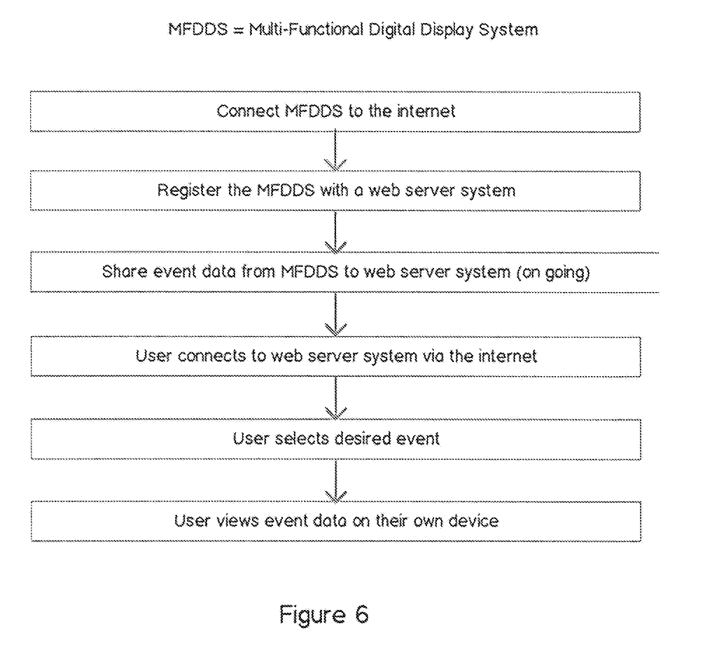

The method of using this system illustrated in FIG. 6 provides a means of allowing users to use an internet connection to view the event data from any multi-functional digital display system that has been registered with the appropriate web server system. In this conception, a specific multi-functional digital display system is connected to the Internet and is registered with a web server system. The event data produced by the multi-functional digital display system is then shared with this web server system on an on-going basis. Users on the internet can now connect to a website or application provided by the web server system, find the multi-functional digital display system in which they are interested, and view event data which has been shared from that multi-functional digital display system. In addition, users connected to the web server system can provide input or feedback to the web server system, which could be delivered to the multi-functional digital display system. Thus, users may get a view of the event data on their own device and may even provide input or participate in appropriate events, whether they are present at the event or not.

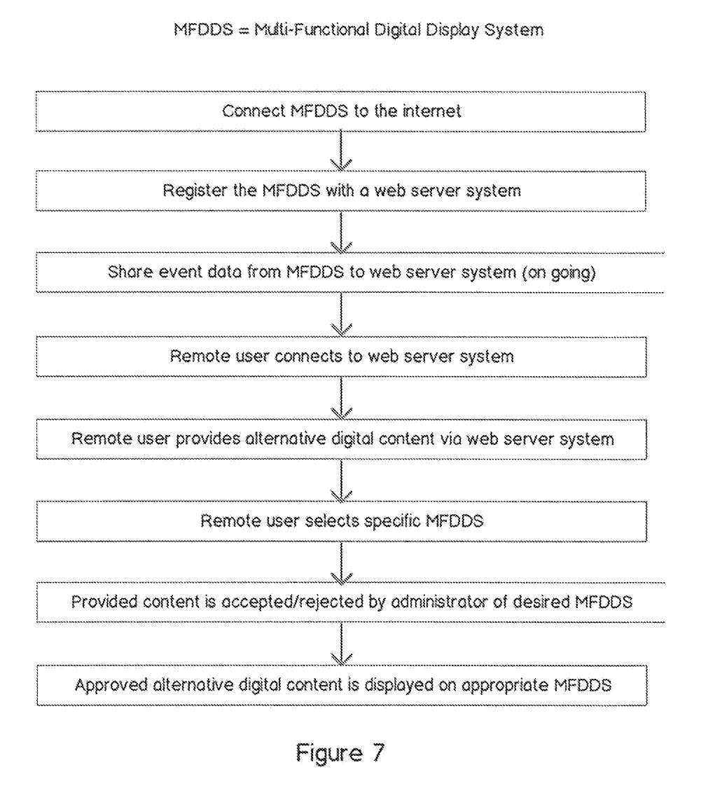

The method of using this system illustrated in FIG. 7 provides a means of collecting and managing alternative digital content to be displayed on a multi-functional digital display system from interested parties via the internet. This method enables a further level of control, use, and automation for the multi-functional digital display system. The system provided in this conception would provide a system for managing the collection, approval, display, tracking, and payment of any alternative digital content displayed on any multi-functional digital display system. This method would be achieved by first connecting a specific multi-functional digital display system to the Internet and registering that system with a web server system. Event data from the specific multi-functional digital display system is shared with the web server system, allowing a user to connect to the web server system and locate the desired event. The user can then chose to provide alternative digital content to be displayed on the multi-functional digital display system. An administrator of that multi-functional digital display system would then be prompted to approve or reject the provided content. If approved, the content would display on the multi-functional digital display system as needed.

What is claimed is:

1. A multi-functional digital display system comprising: a multi-functional digital display device capable of being connected to a standard digital display device via a standard display connection and capable of drawing power from a standard power supply; a computer processor attached to the multi-functional digital display device for enabling calculations, controls, and the use of software; data storage capacity attached to the multi-functional digital display device for storing appropriate information as needed; a web server attached to the multi-functional digital display device for delivering web pages and other information to connected client devices as well as receiving information from the connected client devices; a wireless access point attached to the multi-functional digital display device for enabling bi-directional communication between the multi-functional digital display device and other devices; software attached to the multi-functional digital display device for enabling the control and configuration of the multi-functional digital display device; a standard digital display device connected to the multi-functional digital display device via a standard display connection for the purpose of displaying the output of the multi-functional digital display device; and a standard wireless device connected to the multi-functional digital display device via a standard wireless connection for the purpose of controlling the multi-functional digital display device.

2. A system in claim 1 wherein any event data can be displayed on the connected digital display device.

3. A system in claim 1 wherein any event data can be controlled from a software interface on the connected standard wireless device.

4. A system in claim 1 wherein a software interface is provided on the connected standard wireless device for controlling and customizing what is presented on the connected digital display device.

5. A system in claim 1 wherein the digital display device presents only event data related to a single current event.

6. A system in claim 1 wherein the digital display device presents event data from multiple concurrent events.

7. A system in claim 1 wherein the digital display device presents event data from some combination of past, current, and future events.

8. A system in claim 1 wherein the digital display device presents only alternative digital content.

9. A system in claim 1 wherein the digital display device presents a combination of event data and alternative digital content.

10. A system in claim 1 wherein more than one standard wireless device is connected and sharing control of the system.

11. A system in claim 1 wherein any standard wireless devices which are connected to control the system are authenticated via a standard authentication protocol providing specific access rights according to the authentication.

12. A system in claim 1 wherein more than one multi-functional digital display devices are connected to more than one separate digital display devices such that one of the multi-functional digital display system devices is the server device and the other devices are the client devices.

13. A system in claim 1 wherein the multi-functional digital display server device permanently stores the data of each event and provides a software interface enabling appropriate manipulation and display of the stored event data via a connected standard wireless device.

14. A system in claim 1 wherein a multi-functional digital display system is also connected to the internet.

15. A method comprising the following steps: connecting a multi-functional digital display system to the internet; registering the multi-functional digital display system with a web server system on the internet; sharing event data from the multi-functional digital display system with the web server system on an on-going basis; connecting external devices, which are not directly connected to the multi-functional digital display system, with the web server system via the internet; providing a view of the event data from the multi-functional digital display system to said external devices via a software interface.

16. A method according to claim 15 comprising the following steps: allowing users on said external devices to provide input to or interact with event data from the multi-functional digital display system via a software interface; utilizing input from the connected users in a variety of ways including, but not limited to, directly displaying the input, manipulating the input to display collective results of interest, displaying the input as a part of a game activity.

17. A method according to claim 15 comprising the following steps: allowing users on said external devices to provide alternative digital content to be displayed on the multi-functional digital display system; prompting an administrator of the appropriate multi-functional digital display system to accept or reject the provided content; if approved, displaying said content on the multi-functional digital display system based on the agreed upon terms.

18. A method according to claim 15 comprising the following steps: registering any number of multi-functional digital display systems with said web server system; allowing users on said external devices to provide alternative digital content to be displayed on one or more of the registered multi-functional digital display systems.
